(19) United States
(12) Patent Application Publication
(10) Pub. No.: US 2019/0369344 A1
(43) Pub. Date: Dec. 5, 2019

(54) FIBER RIBBONIZER

(71) Applicant: COMMSCOPE TECHNOLOGIES LLC, Hickory, NC (US)

(72) Inventors: Tamer SCHILLER, Hickory, NC (US); Scott L. CARLSON, Hickory, NC (US); Yu LU, Hickory, NC (US)

(73) Assignee: COMMSCOPE TECHNOLOGIES LLC, Hickory, NC (US)

(21) Appl. No.: 16/465,399

(22) PCT Filed: Dec. 1, 2017
(86) PCT No.: PCT/US2017/064247

§ 371 Date: May 30, 2019

Related U.S. Application Data
(60) Provisional application No. 62/428,567, filed on Dec. 1, 2016.

(51) Int. Cl. G02B 6/44

(52) U.S. Cl. CPC G02B 6/448

(57) ABSTRACT

An apparatus for ribbonizing a plurality of optical fibers into a single ribbon cable for use with a multi-fiber connector having a pitch diameter. The apparatus includes a plurality of spacers for organizing the plurality of optical fibers. The plurality of spacers have a width. The apparatus also includes a plurality of dividers between the plurality of spacers to establish a gap between adjacent receivers. The plurality of dividers also have a width. The apparatus also include a channel for receiving the plurality of optical fiber cables from within the plurality of spacers and applying a laminate thereon. The sum of the width of one of the plurality of spacers and one of the plurality of dividers is greater than the pitch diameter of the multi-fiber connector.

### CROSS-REFERENCE TO RELATED APPLICATION

This application is being filed on Dec. 1, 2017 as a PCT International Patent Application and claims the benefit of U.S. Patent Application Ser. No. 62/428,567, filed on Dec. 1, 2016, the disclosure of which is incorporated herein by reference in its entirety.

### TECHNICAL FIELD

The present disclosure relates generally to an optical fiber ribbon, and particularly to the manufacture of an optical fiber ribbon.

### BACKGROUND

With a demand for high speed communications in the Internet and corporate networks, use of optical fiber cables has been spreading rapidly. The optical fiber is made of quartz glass, and accordingly is quite vulnerable to an external force and an external environment. For this reason, a protective coating layer generally coats the circumference of an optical fiber to protect the optical fiber from the external force and the external environment. The optical fiber thus coated with the protective coating layer is called a coated optical fiber. Then, an optical fiber ribbon in the form of a ribbon is formed in such a way that multiple optical fibers are arrayed and an ultraviolet curable resin coats the circumference of the coated optical fibers.

Since single-mode optical fiber was first introduced in the early 1980's, little has changed in its basic geometric parameters. The central core size has remained between 8-10 micrometers in diameter, the cladding of the glass has remained at 125 micrometers in outside diameter, and the coating is 250 micrometers in outside diameter. Standardizing these dimensions has greatly improved interoperability and consistency across the optical network. Currently, 12-Fiber MT ferrules can only be used with fiber that is 250 micrometers in diameter.

Single-mode optical fibers with a smaller 200, or smaller, -micrometer coating dimension are now available. This new dimension has enabled novel, compact cable designs that give telecom providers new options for their optical networks. A key performance difference occurs when 200, or smaller,-micrometer coated fibers are used in ribbon structures because the coating impacts the spacing of the optical fibers and how they are joined in either a mass fusion splice apparatus or an MPO connector. The fixture used to ribbonize the current 250-micrometer optical fiber cannot be used for ribbonizing 200, or smaller, -micrometer optical fibers because there has been no way of applying an appropriate gap between each fiber. For this reason, the 200, or smaller,-micrometer optical fibers have not been recommended for use in ribbons or multi-fiber junctions. There remains a need for a way to consistently implement a series of 200, or smaller,-micrometer coated fibers into a ribbon structure.

### SUMMARY

An aspect of the present disclosure allows for an optical fiber, smaller/thinner than a 250 micrometer fiber, to be ribbonized and ultimately inserted into a 250 micrometer multi-fiber connector. A gap is applied in between each optical fiber, making it the same pitch diameter (i.e., distance from a point on one fiber to the corresponding point on an adjacent fiber as measured across the horizontal axis between adjacent fibers in a ribbon) as a 250 micrometer fiber. The advantage of the smaller/thinner fiber is that its surface area is smaller than the 250 micrometer fiber, so cables can be placed in smaller tubes creating more space for additional cables. This could be an economic benefit because customers are looking to reduce the size of their cables, and this would satisfy their needs.

A further aspect of the present disclosure relates to an apparatus for ribbonizing a plurality of optical fibers into a single ribbon cable for use with a multi-fiber connector having a pitch diameter. The apparatus includes a plurality of spacers for organizing the plurality of optical fibers. The plurality of spacers have a width. The apparatus also includes a plurality of dividers between the plurality of spacers to establish a gap between adjacent receivers. The plurality of dividers also have a width. The apparatus also include a channel for receiving the plurality of optical fiber cables from within the plurality of spacers and applying a laminate thereon. The sum of the width of one of the plurality of spacers and one of the plurality of dividers is greater than the pitch diameter of the multi-fiber connector.

A still further aspect of the present disclosure relates to a method for ribbonizing a plurality of optical fibers into a single ribbon cable for use with a multi-fiber connector. The method includes organizing the plurality of optical fibers into a parallel orientation with respect to each other, separating the plurality of optical fibers by a starting pitch diameter with respect to each other, and applying a laminate to the plurality of optical fibers. The laminate cures to bind the plurality of optical fibers to have a final pitch diameter adapted for use with the multi-fiber connector.

A yet further aspect of the present disclosure relates to a system for managing a plurality of optical fibers into a single ribbon cable. The system includes a separator with a plurality of dividers arranged in parallel to define a plurality of channels arranged in parallel. The plurality of dividers have unique visual indicators for identifying the plurality of optical fibers within the plurality of channels. The system also has a surface to receive the plurality of optical fibers from within the plurality of channels in the separator. The surface is adapted to support the plurality of optical fibers during application of a curing laminate thereto.

A still further aspect of the present disclosure relates to a system for managing a plurality of optical fibers. The system includes a separator with a plurality of dividers arranged in parallel to define a plurality of channels arranged in parallel. The plurality of dividers include a fixed end and a free end to define an open top of the plurality of channels. The system also includes a surface to receive the plurality of optical fibers from within the plurality of channels in the separator. The surface is adapted to support the plurality of optical fibers during application of a laminate thereto.

### BRIEF DESCRIPTION OF THE DRAWINGS

FIG. 1 is a perspective view of an apparatus for ribbonizing a plurality of optical fibers, according to an example embodiment of the present invention.

FIG. 2 is an enlarged view of the apparatus shown in FIG. 1, showing greater detail of the section within window M.

FIG. 3 is a front view of the apparatus shown in FIG. 1, as viewed along sight line A.

FIG. 4 is an enlarged view of the apparatus shown in FIG. 1, showing greater detail of the section within window N identified in FIG. 3.

### DESCRIPTION OF EXAMPLE EMBODIMENTS

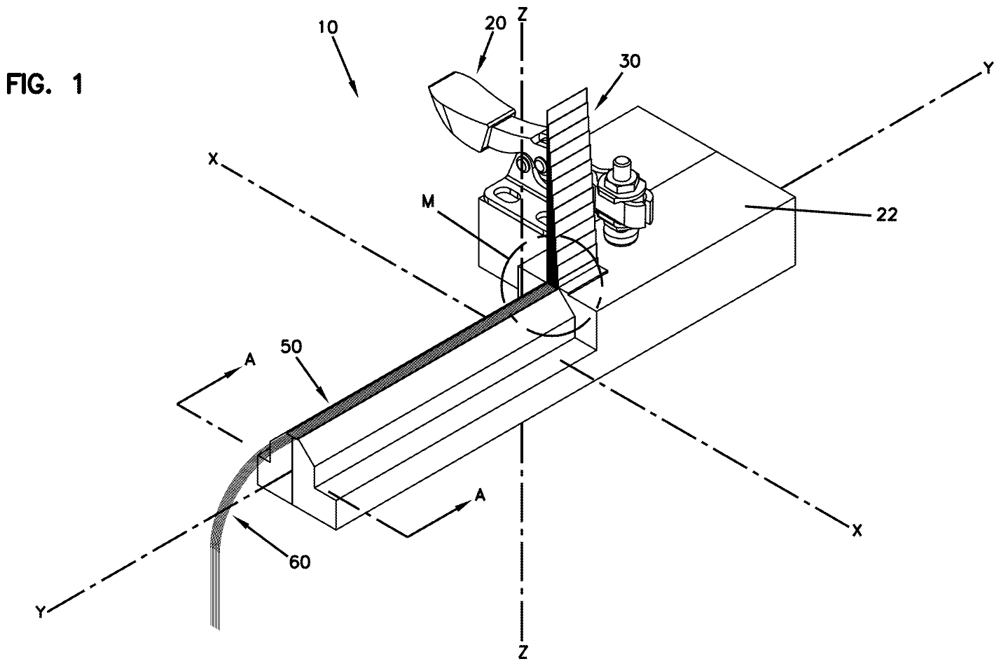

FIG. 1 illustrates an example assembly 10 (or system) for ribbonizing (i.e., organizing into a ribbon structure) a plurality of separate optical fiber cables into an optical fiber ribbon 60 for use with a multi-fiber connector (not shown). The illustrated assembly 10 includes a clamp 20 that is mounted onto a base 22. The clamp 20 receives the plurality of separate optical fibers and organizes them toward a separator 30. The plurality of separate optical fibers are arranged and extended individually through the separator 30. The separator 30 is secured to the base 22 and is oriented along an axis Z. For example, the separator 30 can be a single unit that is dropped down into (inserted into) a receiver (not shown) in the base 22. In this case, the separator 30 can also be removable and replaced with a separator having a different geometry and/or function. The separator 30 arranges the plurality of separate optical fibers evenly along a common plane, which is aligned with an axis X, within a trough 50 that extends along an axis Y. As illustrated, axis X, axis Y and axis Z are perpendicular to each other.

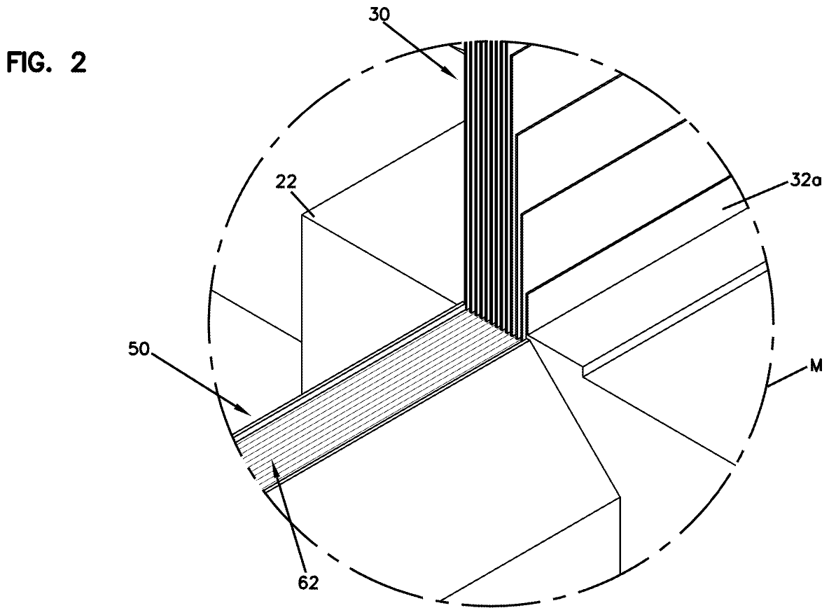

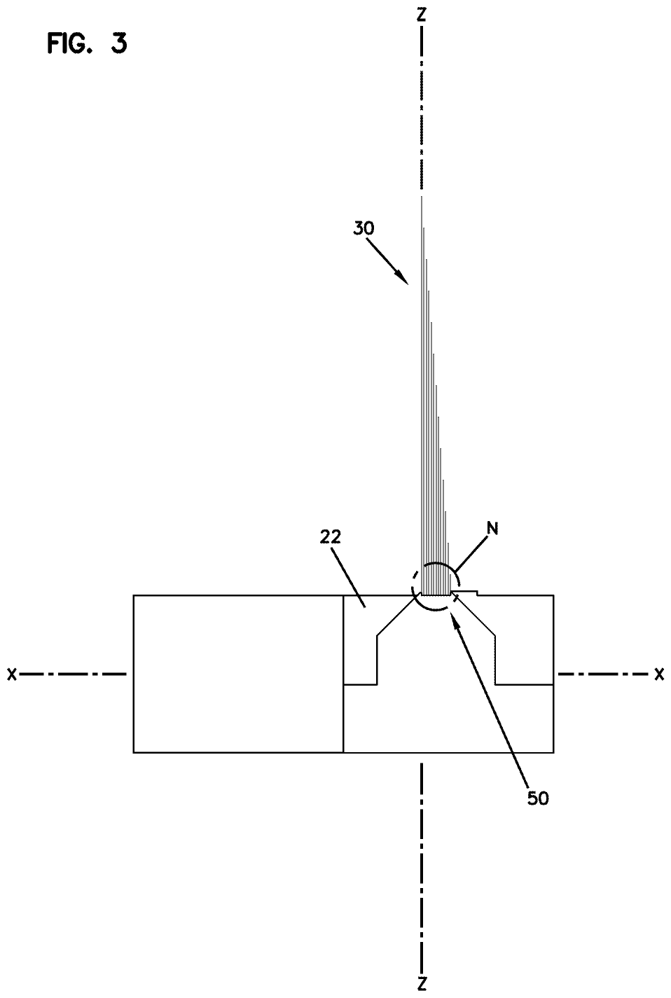

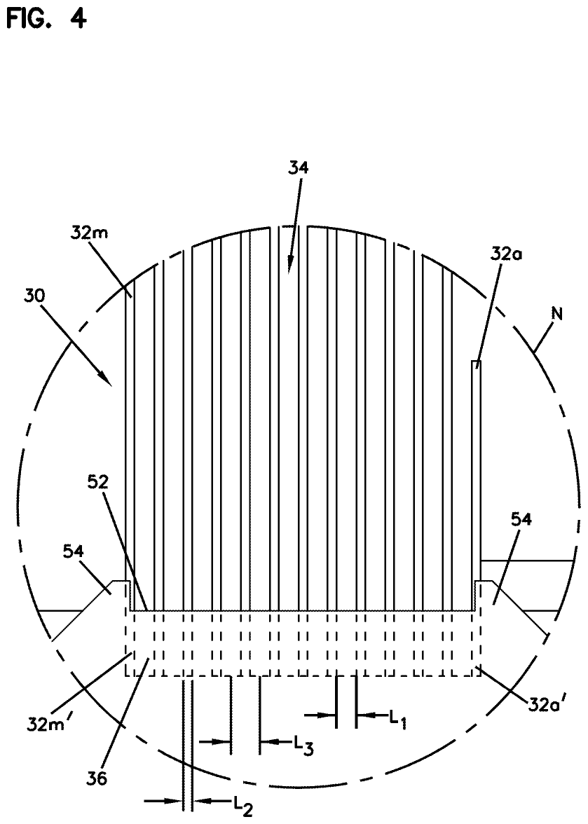

FIG. 2 is an enlarged view of a section of the assembly 10. As illustrated, a plurality of optical fibers 62 are aligned along a common plane (surface) within the trough 50. The number of optical fibers 62 can vary depending on preference. Example numbers of optical fibers 62 that are arranged into the ribbon 60 (FIG. 1) can be 12, 24 and 36. The illustrated separator 30 includes a plurality of dividers (also shown in FIGS. 2, 3 and 4), for example the identified dividers 32a and 32m (numbering used to represent the first ‘a’ and last ‘m’ of 13 illustrated dividers), which can be plates or shims, arranged in parallel to each other and oriented in parallel to axis Z. The number of dividers, for example 32a and 32m, included in the example separator 30 can vary, but preferably is greater than the number of optical fibers 62 to be formed into the ribbon 60. As illustrated, the number of dividers, for example 32a and 32m, in the separator 30 is at least one greater than the number of optical fibers 62 in the ribbon 60, so as to provide an equivalent number of spaces 34 (channels) between dividers (FIG. 4) and number of optical fibers. In use, the optical fibers 62 extend from the clamp 20 (FIG. 1) through the spaces between the dividers, for example 32a and 32m, in the separator 30 and onto the trough 50, where the fibers are applied with, coated, painted or otherwise covered with a laminate, such as an epoxy, which cures, hardens and/or dries to form the single ribbon structure 60.

As illustrated, the height by which each divider, for example 32a and 32m, extends from the base 22 varies. For example, the illustrated plurality of dividers can have a stepped and increasing height from shortest 32a to tallest 32m with respect to the base 22. As illustrated, the difference in height between adjacent dividers in the separator 30 can be consistent from shortest 32a to tallest 32m. Each divider includes a visible indicator or exposed surface, being operable to identify a specific optical fiber 62 extending through a space 34 between adjacent dividers. Example visible indicators can be a unique color, alphanumeric character or other method of identification.

Preferably, each divider, for example 32a and 32m, has a common thickness in the X direction, and a common width in the Y direction.

FIG. 4 illustrates, in more specific detail, the dividers in the separator 30, and the trough 50 (see FIGS. 1-3). The illustrated trough 50 has a channel that is defined by a floor surface 52 extending between a pair of walls 54. As illustrated, the separator 30 can be received within, or dropped into, a receiver (not shown) or similar structure in the base 22 that extends below the floor surface 52 of the trough 30.

The illustrated separator 30 includes sections of the dividers, for example 32a and 32m, extending above the floor surface 52, and supporting sections of the dividers, for example 32a′ and 32m′, extending below the floor surface into the above-described receiver. The illustrated sub-floor sections of the dividers, for example 32a′ and 32m′, are separated from each other by a plurality of spacers, for example spacer 36, in the form of plates or shims. Preferably, each spacer 36 has a common thickness in the X direction, and a common width in the Y direction. The spacers, for example spacer 36, operate to maintain a distance L₁ defined along the X axis between adjacent dividers in the separator 30. The illustrated dividers in the separator 30 can have a common thickness L₂ defined along the X axis. The illustrated spaces 34 between the dividers in the separator 30, above the floor surface 52, can have a common width, for example L₁, defined along the X axis. The gap L₁ is preferably wide enough into which one of the optical fibers 62 (FIG. 2) can be dropped between adjacent dividers from the open top.

Alternatively, the spaces 34 between the dividers in the separator 30 can be wider near the top (distal free end) of each divider than near the bottom (proximal fixed end) close to the floor surface 52. As illustrated, the spaces 34 between the distal free top ends of the dividers is open to allow optical fibers to be inserted. Alternatively still, the dividers in the separator 30 can be flexible along the X axis, such that the width of the spaces 34 between adjacent dividers can adjust wider and narrower depending on use. In example use, a user can quickly and easily organize and arrange the plurality of optical fibers 62 extending from the clamp 20 by, for each optical fiber, flexing two identified adjacent dividers apart and inserting an identified optical fiber through the open top and down into the space 34 therebetween. This allows a user to ensure that a particular optical fiber 62 is inserted into the correct space 34 before exiting the separator 30 onto the trough 50 to become a ribbon cable 60. In one example, the taller divider(s) 32 are flexed away from the shorter divider(s) to widen the space for the user to place the selected fiber in the correct space 34.

Preferably, the gap L₁ between the dividers, or as defining the spacers, is greater than the thickness L₂ of the dividers. Thickness L₃ defines the pitch diameter (i.e., distance from a point on one fiber to the corresponding point on an adjacent fiber as measured across the horizontal axis between adjacent fibers in a ribbon), for example space 34. This pitch diameter or thickness L₃ also defines the distance between common points in adjacent optical fibers 62 which are contained within the separator 30 before being exposed to the laminate. As illustrated, the pitch diameter L₃ within the separator 30 is preferably equivalent to the sum of thickness L₁ and thickness L₂.

In use, the laminate that is applied onto the optical fibers 62 (FIG. 2) as they exit the separator 30 cures, hardens and/or dries to connect the adjacent optical fibers and form one single ribbon cable 60. As the laminate cures, hardens and/or dries, the laminate material shrinks, thus pulling or contracting the adjacent optical fibers 62 toward each other, thus narrowing the cable 60 along the X axis. Preferably, the pitch diameter L₃ of adjacent unlaminated (bare) optical fibers 62 within the separator 30 is greater than an end pitch diameter of the optical fibers in a finished ribbon cable 60 with cured, hardened and/or dried laminate in order to account for this narrowing effect during curing, hardening and/or drying of the laminate.

Preferably, in order to connect the ribbon cable 60 to a 250 micrometer multi-fiber connector with optical fiber receivers having a 250 micrometer pitch diameter, the pitch diameter between adjacent optical fibers 62 in the completed ribbon cable should be 250 micrometers. As a result, the pitch diameter L₃, representing the sum of L₁ and L₂, should be, and is preferably, greater than 250 micrometers when the laminate applied to the optical fibers 62, in consideration of the shrinking of the laminate during hardening and/or drying to a pitch diameter of 250 micrometers in the cable 60. For example, to receive and align each of a plurality of 200 micrometer optical fibers 62 for applying with laminate on the trough 50, the thickness L₁ of each spacer 36, and thereby each space 34 between dividers near the floor surface 52, can be equal to or slightly greater than the width of the 200 micrometer optical fiber. For example, the thickness L₁ of each spacer 36, and thereby each space 34 between dividers near the floor surface 52, can be about 200 micrometers, for example between 201 micrometers and about 203 micrometers. The thickness L₂ of each divider, for example 32a and 32m, can be about 50 micrometers, for example between about 50 micrometers and about 53 micrometers, such that the thickness of L₃, which represents the sum of L₁ and L₂, is at least the same as or slightly greater than 250 micrometers, for example about 253 micrometers. Upon curing, hardening and/or drying of the laminate, and thus narrowing along the X axis, the pitch diameter of the optical fibers 62 in the ribbon cable 60 is 250 micrometers, so as to connect to the 250 micrometer multi-fiber connector.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. An apparatus for ribbonizing a plurality of optical fibers into a single ribbon cable for use with a multi-fiber connector having a pitch diameter, the apparatus comprising:
a plurality of spacers for organizing the plurality of optical fibers, the plurality of spacers comprising a width;
a plurality of dividers between the plurality of spacers to establish a gap between adjacent spacers, the plurality of dividers comprising a width;
a channel for receiving the plurality of optical fiber cables from within the plurality of spacers and applying a laminate thereon; and
wherein the sum of the width of one of the plurality of spacers and one of the plurality of dividers is greater than the pitch diameter of the multi-fiber connector.

2. The apparatus of claim 1, wherein the plurality of optical fibers comprise a pitch diameter within the plurality of spacers and a pitch diameter after being ribbonized into a single ribbon cable, the pitch diameter within the plurality of spacers being greater than the pitch diameter in the ribbon cable.

3. The apparatus of claim 1, wherein the plurality of dividers comprises an identification element for managing the plurality of optical fibers.

4. The apparatus of claim 1, wherein the plurality of dividers are a plurality of plates arranged in parallel defining the plurality of spacers between adjacent plates.

5. The apparatus of claim 1, wherein the plurality of plates comprise a fixed end and a free end, the plurality of optical fibers being received into the plurality of spacers between the free ends of adjacent plates.

6. The apparatus of claim 1, wherein the plurality of spacers comprise a variable depth.

7. The apparatus of claim 1, wherein the variable depth of the plurality of spacers is defined between adjacent plates.

8. The apparatus of claim 1, wherein the plurality of plates comprise a variable height with respect to the fixed end.

9. The apparatus of claim 1, wherein the free end of the plates is flexible to adjust the width of the spacers between adjacent plates.

10. The apparatus of claim 1, wherein the channel comprises a trough extending away from the plurality of dividers and spacers.

11. The apparatus of claim 1, wherein the width of the spacers is greater than the width of the dividers.

12. The apparatus of claim 1, wherein the width of the spacers is between about 200 micrometers and about 250 micrometers.

13. The apparatus of claim 1, wherein the width of the spacers is between about 201 micrometers and about 203 micrometers.

14. The apparatus of claim 1, wherein the width of the dividers is between about 50 micrometers and about 53 micrometers.

15. A method for ribbonizing a plurality of optical fibers into a single ribbon cable for use with a multi-fiber connector, the method comprising:
organizing the plurality of optical fibers into a parallel orientation with respect to each other;
separating the plurality of optical fibers by a starting pitch diameter with respect to each other; and
applying a laminate to the plurality of optical fibers, wherein the laminate cures to bind the plurality of optical fibers to have a final pitch diameter adapted for use with the multi-fiber connector.

16. The method of claim 15, wherein the multi-fiber connector comprises a plurality of 250 micrometer optical fiber receivers, and the plurality of optical fibers have a 200 micrometer diameter.

17. The method of claim 15, wherein the laminate shrinks during curing to reduce the starting pitch diameter to the final pitch diameter.

18. The method of claim 15, wherein the plurality of optical fibers are separated with a plurality of divider plates comprising a variable height with respect to each other.

19. A system for managing a plurality of optical fibers into a single ribbon cable, the system comprising:
a separator comprising a plurality of dividers arranged in parallel to define a plurality of channels arranged in parallel, the plurality of dividers comprising unique visual indicators for identifying the plurality of optical fibers within the plurality of channels; and
a surface to receive the plurality of optical fibers from within the plurality of channels in the separator; the surface adapted to support the plurality of optical fibers during application of a curing laminate thereto.

20. The system of claim 19, wherein the plurality of dividers comprise a variable height with respect to each other, and the unique visual indicators is the difference in height between the plurality of dividers.

21. A system for managing a plurality of optical fibers, the system comprising:
a separator comprising a plurality of dividers arranged in parallel to define a plurality of channels arranged in parallel, the plurality of dividers comprising a fixed end and a free end to define an open top of the plurality of channels; and
a surface to receive the plurality of optical fibers from within the plurality of channels in the separator; the surface adapted to support the plurality of optical fibers during application of a laminate thereto.

22. The system of claim 21, wherein the plurality of dividers comprise a variable height with respect to each other.

23. The system of claim 21, wherein the plurality of dividers are arranged from shortest to tallest.
